(19) United States
(12) Patent Application Publication
(10) Pub. No.: US 2002/0034312 A1
(43) Pub. Date: Mar. 21, 2002

(54) Capacitor microphone

(75) Inventor: Masaharu Ikeda, Yokohama (JP)

Correspondence Address: Connolly Bove Lodge & Hutz LLP, Suite 800, 1990 M Street, N.W., Washington, DC, 20036-3425, US

(73) Assignee: Matsushita Electric Industrial Co., Ltd., Osaka (JP)

(21) Appl. No.: 09/876,160

(22) Filed: Jun. 8, 2001

(30) Foreign Application Priority Data
Jun. 8, 2000 (JP) 2000-171552

(51) Int. Cl. H04R 25/00

(52) U.S. Cl. 381/174

(57) ABSTRACT

A capacitor type of microphone is capable of securely suppressing generation of noise outputs due to RF signals received from outside the microphone. The microphone includes a movable electrode vibrating in response to a sound vibration and a fixed electrode arranged face to face to the movable electrode, thus forming a capacitor for detecting sound. The microphone further includes first amplification means for buffer-amplifying a terminal voltage across the capacitor and second amplification means cascaded between an output terminal of the first amplification means and a microphone output terminal. Each of the first and second amplification means includes an FET (field effect transistor), for example. An impedance-converting function provided by the second amplification means enables noise outputs due to RF signals radiated or transmitted from the transmitter of a radio apparatus to be reduced in a wide range of carrier frequencies.

### BACKGROUND OF THE INVENTION

1. Field of Invention

The present invention relates to a capacitor type of microphone that converts a sound signal into an electrical signal, and in particular, to a capacitor type of microphone in which an impedance conversion element is contained.

2. Description of the Related Art

One conventional capacitor (condenser) type of microphone proposed by Japanese Utility Model Laid-open Publication No. 58-85889 has been known. This microphone has an insulator for sustaining a back electrode and forming an exhaust room. In part of the insulator, there is formed a containing room for containing therein an element for converting electric impedance, of which input terminal is electrically connected with the back electrode.

When using such capacitor microphone with a radio apparatus, such as a portable telephone, there is a problem that noise mixes in the microphone by radiation of an RF signal from the transmission section of the radio apparatus. To avoid mixing of this noise, the technique of equipping the input section of a power supply circuit with a low-pass filter is known, as disclosed for example by Japanese Utility Model Laid-open Publication No. 62-58994.

The conventional capacitor type of microphone uses another technique to prevent mixing of the noise, like the foregoing low-pass filter. The technique is to place a bypass capacitor to have noise bypassed at a source and a drain of an FET for buffer-amplification in the microphone.

In cases the capacitor type of microphone thus configured is incorporated in a portable telephone and others, it is frequent that the microphone is arranged apart from an antenna of such device depending on design or others The reason is that the receiver should be close to the user's ear, the microphone should be close to the user's mouse, and the antenna is arranged closely to the receiver. The higher an attached position of the antenna, the larger its radiation.

However, the length of an antenna has become short, because the device has miniaturized and a carrier frequency has been raised in recent years. As a result of it, various inconveniences resulted from the shortened antenna have become conspicuous One inconvenience is frequently due to the fact that, though the radiation from the antenna induces a high RF voltage in an opposite-side area to the antenna, the miniaturization makes the microphone locate within such radiation field. In the case that such positional relationship to the microphone is realized, an RF voltage applied to the microphone also becomes high, thus noise to be mixed being large in intensity. Moreover, if the wire length in the capacitor type of microphone is longer, it becomes easier for the RF voltage to be mixed in a communicated signal, in dependence on the length.

It is therefore almost impossible for the capacitor type of microphone to securely prevent noise resulting from the RF voltage from being mixed, by only the conventionally used low-pass filter or bypass capacitor. Further, some portable telephones involve two frequency bands, so such measures to remove noise should be taken for each frequency band. However, the conventional capacitor type of microphone has no preventing measures against noise due to such different RF signals.

### SUMMARY OF THE INVENTION

An object of the invention is to provide a capacitor type of microphone capable of suppressing noise outputs caused by an RF signal attributable to radiation or signal transmission from an external source such as the transmitter of a radio system.

In order to realize the above object, the capacitor type of microphone according to the present invention is provided with a movable electrode vibrating in response to a sound vibration; a fixed electrode arranged face to face to the movable electrode; first amplification means for buffer-amplifying a terminal voltage between the movable electrode and the fixed electrode; and second amplification means cascaded to the first amplification means between an output terminal of the first amplification means and a microphone output terminal. An impedance-converting function provided by the second amplification means enables noise outputs due to RF signals radiated or transmitted from the transmitter of a radio apparatus, that is, from outside the microphone to be reduced in a wide range of carrier frequencies.

### BRIEF DESCRIPTION OF THE DRAWINGS

In the appended drawings:

FIG. 1 is a circuit diagram that outlines the electric configuration of a capacitor type of microphone according to a first embodiment of the present invention;

FIG. 2A is a longitudinal section view that outlines the physical configuration of a capacitor microphone unit 10 employed in the first embodiment;

FIG. 2B is the plan view showing an outlined structure of the output terminals of the capacitor microphone unit 10 employed by the first embodiment; and

FIG. 3 is a circuit diagram that outlines the electric configuration of a capacitor type of microphone according to a second embodiment of the present invention.

### DESCRIPTION OF THE PREFERRED EMBODIMENTS

Referring to the accompanying drawings, preferred embodiments of the present invention will now be described.

(First Embodiment)

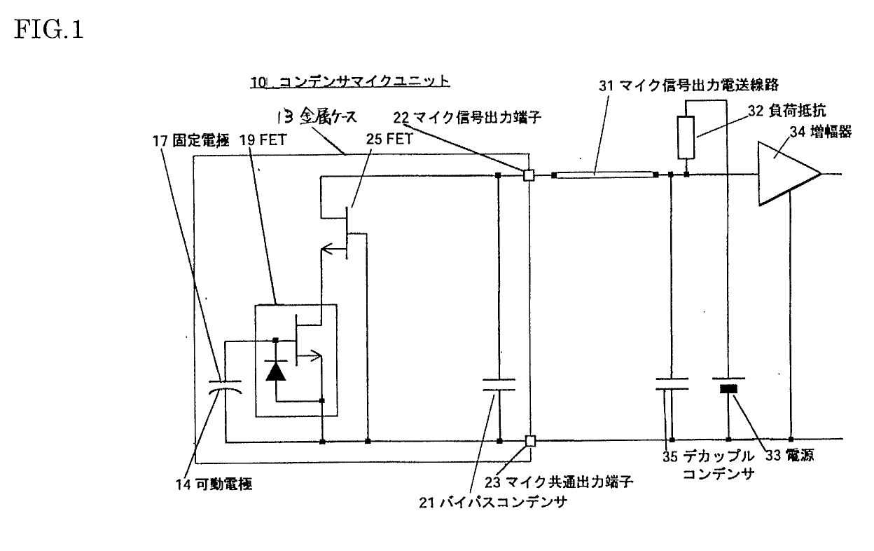

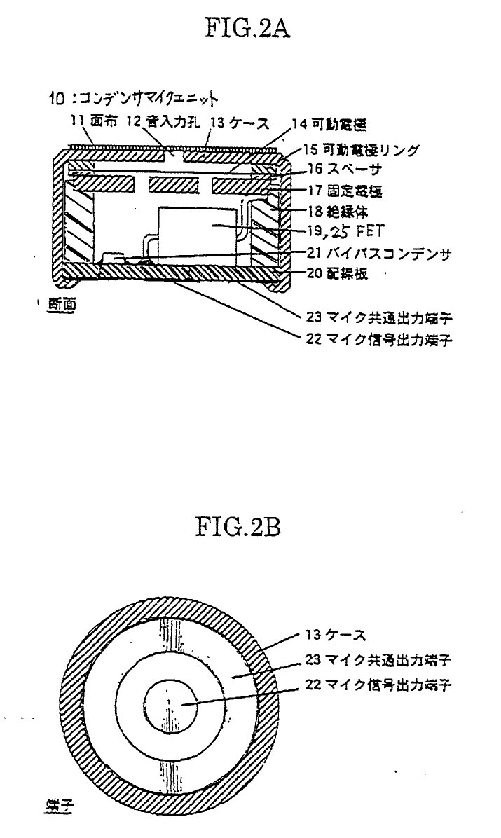

Referring to FIGS. 1, 2A and 2B, a first embodiment will now be explained.

FIG. 1 shows a circuit diagram that outlines the electric configuration of a capacitor (condenser) type of microphone according to the first embodiment, while FIGS. 2A and 2B illustrate views of sectional structures of the microphone.

The capacitor type of microphone is equipped with a capacitor microphone unit 10.

This capacitor microphone unit 10 has a metal casing 13 that serves as an electromagnetic shielding member as well, in which an essential body structure and electric circuit elements are contained.

As shown in FIG. 2A, a sound entrance opening 12 is formed in a sound input surface of the metal casing 13, and the whole sound input surface is covered with a surface cloth to prevent dusts from coming inside.

As shown in FIG. 2A, the metal casing 13 contains therein a movable electrode 14 which vibrates in response to sound vibrations, movable electrode ring 15 which supports the movable electrode 14, fixed electrode 17, spacer 16 which insulates the fixed electrode 17 from the movable electrode 14, and insulator 18 which supports the fixed electrode 17 while insulating it.

Both of the movable electrode 14 and the fixed electrode 17 may be formed either with an electret material itself or a member produced by coating its surface with an electret materiel and accumulating charges on the surface. A capacitor is formed by those electrodes 14 and 17 and the spacer 16.

As shown in FIGS. 1 and 2A, the metal casing 13 contains therein an FET 19 (including a diode serving as an element for setting up a bias) which carries out buffer amplification of the voltage generated in the capacitor provided with the movable electrode 14 and the fixed electrode 17. The metal casing 13 also contains a wiring board 20 for wiring of a circuit and for sealing the back, a bypass capacitor 21 to cause an RF signal coming from the outside to be bypassed to a common output terminal, a microphone signal output terminal 22, a microphone's common output terminal (ground terminal) 23, and a second FET 25 (the second amplification means) connected in cascade to the FET19 (the first amplification means). The FET 25 functions as impedance conversion means. In addition, an FET that uses a resistor as a bias setting element can also be used as the FET 19.

In this configuration, a source of the FET 25 is connected to a drain of the FET 19, while the drain thereof is used as the microphone signal output terminal 22. Both of a gate of the FET25 and a source of the FET 19 are connected to a common line. A gate and the source of the FET 19 are connected to a capacitor with the fixed electrode 17 and the movable electrode 14. Furthermore, the bypass capacitor 21 is arranged in parallel to the FETs between the drain and gate of the FET 25, i.e., between the microphone signal output terminal 22 and the microphone's common output terminal 23.

The microphone signal output terminal 22 and the microphone's common output terminal 23 are both formed on the wiring board 20 with circuits wired, as shown in FIGS. 2A and 2B.

As shown in FIG. 1, the FET 19 is structured into a source common amplifier, and is provided with an element (diode) for setting up a bias therein. The gate of the FET 25 is connected to the microphone's common output terminal (ground terminal) 23, the source thereof to the drain of the FET 19, and the drain thereof to the microphone signal output terminal 22, respectively, thus being structured into a gate common amplifier.

To the microphone signal output terminal 22 of the capacitor microphone unit 10, connected is a microphone signal output line 31 used for wiring on a mother board of devices such as a portable telephone. On the other hand, the microphone's common output terminal 23 is connected with a common line. In the exterior field of the capacitor microphone unit 10, connected between the microphone signal output line 31 and the common line are a decoupling capacitor 35, load resistor 32, power supply 33, and amplifier 34, as shown in FIG. 1. The decoupling capacitor 35, which includes stray capacitors generated between layers of the microphone signal output line 31 and a ground pattern, functions so as to reduce an RF signal impinging on the microphone signal output line 31. The load resistor 32, power supply 33, and amplifier 34 are arranged on the mother board of devices such as a portable telephone.

In terms of RF signals, the microphone signal output line 31 is regarded as being connected to the ground at the location of the decoupling capacitor 35 through the decoupling capacitor 35.

In addition, FIG. 2B illustrates the output terminals of this capacitor type of microphone. The plane forms of the terminals are circles, respectively. For this reason, the terminals are formed in the shape of concentric circles on the wiring board 20 so that contact can be taken, even if directions do not become settled. Instead of the terminal configuration shown therein, terminals with pins may be employed.

First, a sound detection function as a microphone will now be described.

In the configuration shown in FIG. 1, sound vibrations which have came through the sound entrance opening 12 gives mechanical displacements to the movable electrode 14. This causes the distance between the movable electrode 14 and the fixed electrode 17 to be changed, so that the changes are converted into changes in the capacitance C. Since the charge Q accumulated on the surface is fixed, changes in the capacitance C serves as terminal voltage V (the relationship of charge Q=capacitance C×voltage V). The signal voltage proportional to sounds vibrations is applied to the gate and source of the FET 19. So the signal voltage is converted into changes in the drain current thereof which is multiplied by a mutual conductance gm of the FET19, thus a signal current being produced which then flows into the source of the FET 25. The FET 25 is formed into a gate common transistor, with the result that the signal current at the source is outputted, as it is, as the signal current from the drain. The drain signal current is then supplied to the load resistor 32 via the microphone signal output terminal 22, and converted to a sound signal voltage by the load resistor 32 (1 to 2 kΩ), which is a product of a signal current value and a load resistance.

A function of preventing RF signals from being invaded from the microphone signal output terminal 22 will now be described.

If the FET 25 of the cascade connection is not arranged, an RF signal is applied to the microphone signal output terminal 22 through the microphone signal output line 31, thereby being supplied to the drain of the FET 19. This RF signal is supplied to the gate of the FET 19 via the capacitor between the drain and gate thereof, at which the RF signal is AM-detected by the bias-setting diode of the FET 19 or PN junction between the channel and gate of the FET 19, thus being converted into noise in the audio band.

By contrast, in the present embodiment, the cascaded amplifier composed of the FET 25 is placed at the drain side of the FET 19. As a result, this cascaded amplifier exhibits a low impedance when electrically viewed from the source side which is an input terminal, while it exhibits a high impedance electrically viewed from the drain side which is an output terminal. That is, the FET 25 shows an impedance converting function to changes the value of the impedance according to the directions of signal flows. This impedance converting function suppresses, to a large extent, the feedback (mixing) of a signal from the output terminal to the input terminal. Therefore, the RF signal voltage caused at the microphone signal output terminal 22 to which the drain of the FET 25 is connected is attenuated sharply, and only the residual is sent to the drain of the FET 19. Noise due to RF signals radiated or transmitted from a transmitter section of radio devices can be suppressed to lower levels.

In addition, although the capacitor type of microphone according to the first embodiment has employed the FET 25 as the second amplification means which is placed within the casing 13 of the capacitor microphone unit 10, this configuration may be changed. As long as electrical connection conditions are satisfied, the same effect as the above will be acquired even if the FET 25 is arranged at other places.

(Second embodiment)

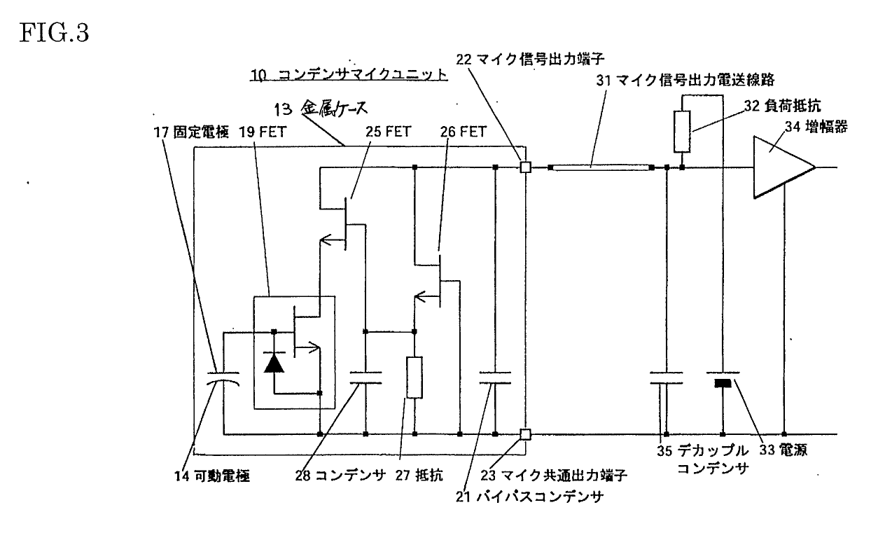

Referring to FIG. 3, a second embodiment of the present invention will now be described.

A capacitor type of microphone according to the second embodiment provides a configuration in which signal distortions on account of a potential relationship among the elements of the microphone described in the foregoing first embodiment.

Specifically, as shown in FIG. 1, the microphone shown in the foregoing first embodiment uses the FET 25 of which gate is directly grounded. As a result, the source potential of the FET 25 turns into the drain potential of the FET 19, as it is. Therefore, when neither a pinch-off voltage of the gate of the FET 25 nor a zero-bias drain current Idss of the FET 25 can be set to a amount which is greater enough, the drain potential of the FET 19 cannot be secured. In such cases, distortions of signals whose amplitude is larger may be increased.

The capacitor type of microphone according to the second embodiment has the function to securely prevent generation of signal distortions even in such a case.

FIG. 3 shows electrical circuitry of the capacitor type of microphone that has such a prevention function. This circuitry is different from that of the microphone shown in the first embodiment (refer to FIG. 1) in that there is additionally provided bias means for supplying a bias potential to the gate of the FET 25 serving as the second amplification means. The bias means has the function which eases conditions with regard to the pinch-off voltage of the gate of the FET 25 and the zero-bias drain current Idss thereof.

In the constituents shown in FIG. 3, the same or identical ones to those in FIG. 1 use the same reference numerals and the explanation will be omitted or simplified.

In the circuitry shown in FIG. 1 (the first embodiment), the gate of the FET 25 is directly grounded, but in the circuitry shown in FIG. 3 (the second embodiment), the gate of the FET is connected to the source of another FET 26. This FET 26 is equipped with a resistor 27 placed between the source and the ground so as to be configured into a self-bias element. Because the drain current of the FET 26 becomes almost constant, the source potential of the FET 26 determined by a voltage drop across the resistor 27 is also approximately constant. Thus, the gate of the FET 25 is biased, so that the drain potential of the FET 19 can be set to a higher value than that in FIG. 1, thereby distortions being prevented from increasing even if signals are higher in amplitude. A capacitor 28 has it to be bypassed to the ground an RF current passing through a stray capacitor between the drain and gate of the FET 25.

Thus, while having the operations and advantages equivalent to the first embodiment, the capacitor type of microphone according to the second embodiment is able to steadily secure the drain potential of the FET 19. In addition, the microphone of the second embodiment suppresses signal distortions, so a stable and high-quality sound output function is provided.

By the way, in the microphone of the second embodiment, the FET 25 serving as the second amplification means, and the FET 26, resistor 27 and capacitor 28 all serving as the bias means are mounted within the casing of the capacitor microphone unit 10. However, if electrical conditions required be met, those elements can be mounted at other locations, with the same effect acquired.

In addition, as to the FET 25 composing the second amplification means in the first and second embodiment, and the FET 26, resistor 27 and capacitor 28 all composing the bias means, those elements may be mounted, entirely or in part, so closely to the mother board of devices, such as a portable telephone, that make use of the capacitor type of microphone. In such a case, the similar advantages to the above can be acquired.

Furthermore, those elements may be mounted on a child board (a piece of board) prepared between the capacitor type of microphone and the mother board. This construction is suitable when connection with the mother board of devices is made using lead wires or a flexible printed circuit board. Moreover, other electrostatic-proof parts (varistor or others), radio-interference-proof cure parts (high-capacity ceramic capacitor or others) can be mounted on such child board. In this case, the foregoing microphone signal output terminal is not limited to the form of contact type as described in the first and second embodiments, but may be formed into a pin-terminal type that can be mounted on the child board.

Moreover, since there is no bias means for the FET 25 in the first embodiment, only the signal current passes the microphone signal output terminal 22. In contrast, the second amplification means placed in the second embodiment requires current consumed by the FET 26 itself serving as the bias means. This current is taken in through the microphone signal output terminal 22, which has a possibility of affecting the microphone signal current in the conventional case. However, in the case of the second amplification means of the second embodiment, the drain current of the FET 26 which is part of the bias means is constant current, thus no affection being given to the microphone output signal.

In the first and second embodiments, the FET 25 serving as the second amplification means has been placed to be connected to the drain of the FET 19. An alternative is that the FET 25 may be arranged to be coupled with the source of the FET 19, provided the FET 25 is changed from the N-channel to the P-channel type in order to the opposite polarities to the FET 19.

Further, the first and second embodiments use an FET as the element for composing the second amplification means. However, any elements that permit a cascaded amplifier can be used. For example, a junction type transistor configured into a base-common amplifier can be adopted and has the same effect. Specifically, the junction type transistor configured into such base-common amplifier is connected such that its emitter accepts the output current from the first amplification means, whilst its collector current is sent to the output terminal of the microphone.

In this case, since the emitter potential is lower than the base potential, the base should be biased by an amount of 0.7 V or more. However, when a higher sound signal is received, a potential at the microphone signal output terminal is lowered than the bias potential, resulting in that such higher bias potential would not be used without any measures. Therefore, in cases the potential at the microphone signal output terminal is larger than a necessary value, the bias potential applied to the base is taken in to be charged, while when such potential is lower than the value, such taking is intercepted to discharge the power that has been charged so far.

Moreover, although the FET 19 is used for the buffer amplification means in the first and second embodiments, other elements, such as an operational amplifier involving an FET input, is available to the buffer amplification means. Any elements of which output signals are dealt as current will provide the same effect.

In the first and second embodiments, an attenuated RF voltage is applied to the drain of the FET 19, but a relatively higher RF voltage is applied to the microphone signal output terminal 22. Hence this higher RF voltage is transmitted via the inner space of the capacitor microphone unit to the fixed electrode 17 and the gate of the FET 19 both having a higher impedance, which results in noise. This noise can be suppressed by placing an electrostatic shield between the fixed electrode 17 and the gate of the FET 19, and the microphone signal output terminal 22 and the FET 25 (and the FET 26) connected to the terminal 22.

Further, the first and second embodiments exemplify the capacitor type of microphone in which the fixed electrode 17 is separated from the casing 13. Alternatively, the fixed electrode 17 can be structured so that it is used in common for the casing 13, the same functions and advantages as those explained before being provided.

Still further, as the way of converting sound vibrations into electrical signals, the first and second embodiments adopt the movable electrode 14 and the fixed electrode 17 on either of which electric charges are accumulated. Available alternatives to this construction include the way of receiving the bias voltage from outside the microphone, the way of detecting in voltage an applied AC bias using a high impedance element, which are able to provide the similar operations and advantages as above.

As stated so far, in the capacitor type of microphone according to the first and second embodiments, noise outputs attributable to RF signals radiated or transmitted from transmitting sections of radio apparatuses, or from outside the microphone are reduced in a steady manner. In addition, electric parts to be added to obtain such noise-reducing function can also be reduced in number.

What is claimed is:

1. A capacitor type of microphone comprising:
a movable electrode vibrating in response to a sound vibration;
a fixed electrode arranged face to face to the movable electrode;
first amplification means for buffer-amplifying a terminal voltage between the movable electrode and the fixed electrode; and
second amplification means cascaded to the first amplification means between an output terminal of the first amplification means and a microphone output terminal.

2. The microphone according to claim 1, wherein the second amplification includes drive means, in which a power supply to the drive means is configured so that the power is obtained as a constant current from outside the microphone via the microphone output terminal.

3. The microphone according to claim 1, wherein the second amplification includes drive means, in which a power supply to the drive means is configured so that the power is temporarily obtained for storage through the microphone output terminal according to voltage values and the stored voltage is used when obtaining the power is stopped.

4. The microphone according to claim 1, wherein the second amplification means is composed of an FET (field effect transistor) structured into a gate-common amplification circuit, a source electrode of the FET receiving an output current of the first amplification means and a drain current of the FET passing to the microphone output terminal.

5. The microphone according to claim 1, wherein the second amplification means is composed of a junction type of transistor structured into a base-common amplification circuit, an emitter electrode of the transistor receiving an output current of the first amplification means and a collector current of the transistor passing to the microphone output terminal.

6. The microphone according to claim 4, wherein the second amplification means is composed of the FET of which gate is connected to a common output terminal of the first amplification means, the source electrode of the FET receiving the output current of the first amplification means and the drain current of the FET passing to the microphone output terminal.

7. The microphone according to claim 1, wherein the first amplification means is composed of an FET (field effect transistor).
